(19) United States
(12) Patent Application Publication
(10) Pub. No.: US 2019/0313871 A1
(43) Pub. Date: Oct. 17, 2019

(54) FILTER CLEANING MECHANISM

(71) Applicants: Fu Tai Hua Industry (Shenzhen) Co., Ltd., Shenzhen (CN); HON HAI PRECISION INDUSTRY CO., LTD., New Taipei (TW)

(72) Inventors: YING-WEI SHENG, New Taipei (TW); CHUN-KAI PENG, New Taipei (TW); CHIA-WEI LIU, New Taipei (TW); KE-PENG YI, Shenzhen City (CN); DAI-HONG CAI, Shenzhen (CN)

(21) Appl. No.: 16/207,947

(22) Filed: Dec. 3, 2018

(30) Foreign Application Priority Data
Apr. 16, 2018 (CN) 201810338186.X

(51) Int. Cl. A47L 9/20; B01D 46/10; B01D 46/04; B01D 46/28

(52) U.S. Cl. CPC A47L 9/20; B01D 46/10; B01D 41/04; B01D 46/28; B01D 46/04

(57) ABSTRACT

A filter cleaning mechanism includes a sliding rail, a filter, a dust box, a cleaning device, and a driver. The filter is mounted to the sliding rail. The dust box is mounted to a bottom of the sliding rail. The cleaning device is mounted in front of the filter and above the dust box. The cleaning device includes a cleaning brush and a screen. The driver is mounted to a side of the sliding rail and is electrically coupled to the cleaning device. The driver moves up and down along the sliding rail. The cleaning brush and the screen move along with the driver up and down the sliding rail. The driver drives the cleaning brush to brush the filter. The screen blocks the front of the filter while the cleaning brush brushes the filter.

### FIELD

The subject matter herein generally relates to air filters, and more particularly to a filter cleaning mechanism of an air filter.

### BACKGROUND

Generally, a filter of an air filter will accumulate dust and dirt after an extended period of use. The filter needs to be removed to clean the dust and dirt from the filter.

### BRIEF DESCRIPTION OF THE DRAWINGS

Implementations of the present disclosure will now be described, by way of embodiments, with reference to the attached figures.

FIG. 1 is an assembled, isometric view of an air filter having a filter cleaning mechanism in accordance with an embodiment of the present disclosure.

FIG. 2 shows the air filter of FIG. 1 with the filter cleaning mechanism in operation.

FIG. 3 is another view of the air filter of FIG. 1 with the filter cleaning mechanism in operation.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

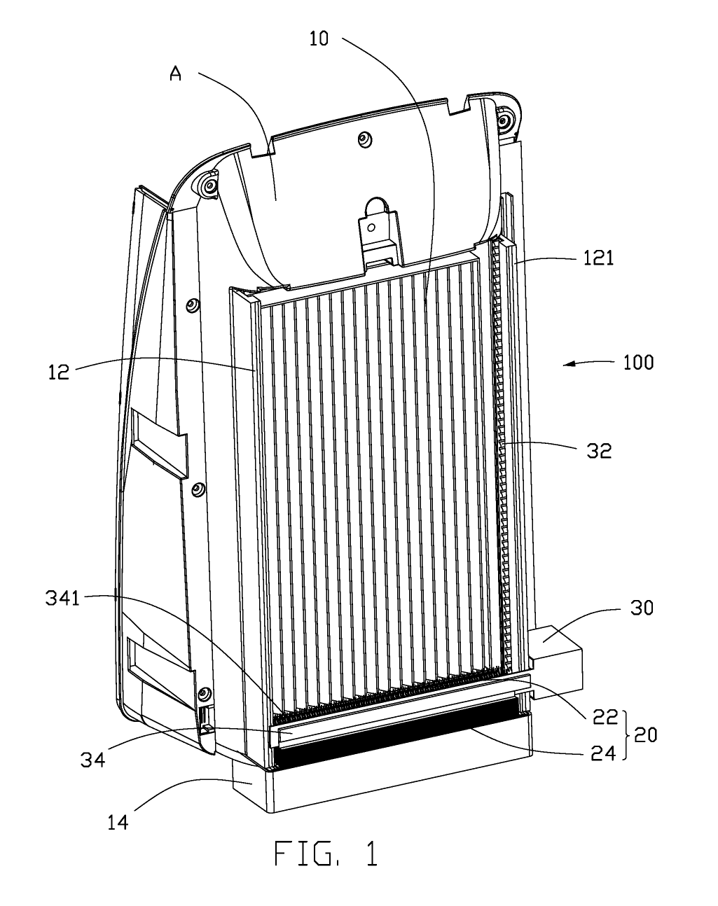

FIG. 1 shows an embodiment of a filter cleaning mechanism 100 used in an air filter A. The filter cleaning mechanism 100 includes a filter 10, a cleaning device 20, and a driver 30. The filter 10 is mounted to a sliding rail 12. A dust box 14 is mounted at a bottom of the sliding rail 12. The cleaning device 20 is mounted in front of the filter 10 and above the dust box 14. The cleaning device 20 includes a cleaning brush 22 and a screen 24. The driver 30 is mounted to a side 121 and is electrically coupled to the cleaning device 20. The driver 30 moves up and down along the sliding rail 12, and the cleaning brush 22 and the screen 24 follow the driver 30 to move up and down along the sliding rail 12. The cleaning brush 22 is driven by the driver 30 to brush the filter 10, and the screen 24 blocks the front of the filter 10 while the cleaning brush 22 brushes the filter 10.

The filter cleaning mechanism 100 is mounted to a rear air intake vent of the air filter A. The filter 10 filters the air flowing through the rear air intake vent. The cleaning device 20 is driven by the driver 30 to clean the filter 10. In one embodiment, the driver 30 is mounted to the side 121 of the sliding rail 12. The driver 30 is coupled to the sliding rail 12 by a linking component 32 to enable the driver 30 to move up and down along the sliding rail 12. The linking component 32 ascends and descends vertically. The linking component 32 may include a gear mechanism, a belt mechanism, or a sleeve mechanism. For example, the gear mechanism may include a worm screw and a worm wheel. The worm screw is mounted to the side 121 of the sliding rail 12, and the worm wheel meshed with the worm screw is coupled to the driver 30 to cause the worm screw to rotate back and forth, thereby driving the driver 30 to move up and down the sliding rail 12. The driver 30 includes a mounting bracket 34 mounted across the sliding rail 12 from the driver 30. The mounting bracket 34 is mounted in front of the filter 10. The cleaning brush 22 is mounted on an inner side of the mounting bracket 34. The screen 24 is mounted between the mounting bracket 34 and the dust box 14. The mounting bracket 34 follows the driver 30 up and down along the sliding rail 12.

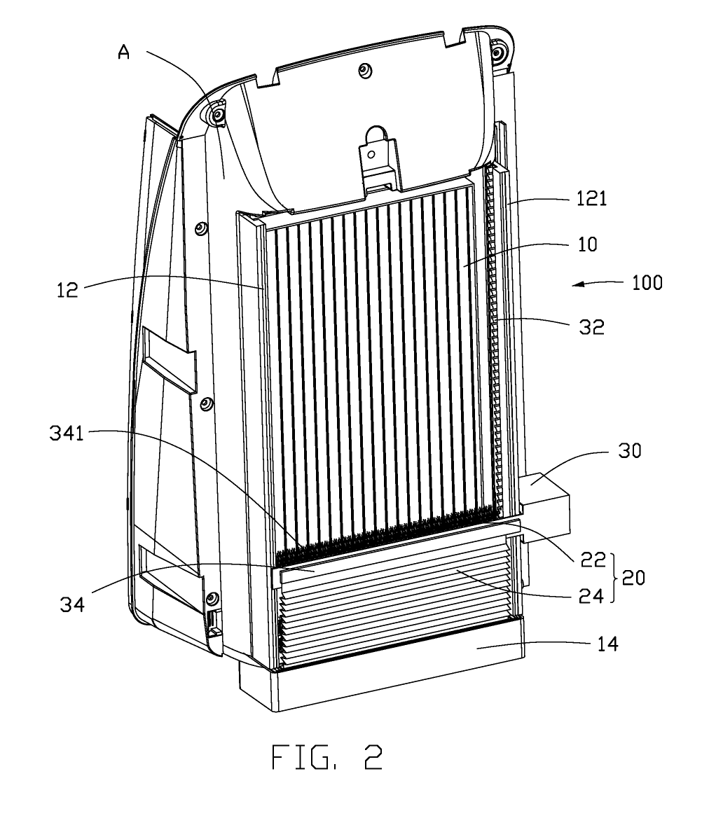

As shown in FIG. 2, the mounting bracket 34 follows the driver 30 up and down the sliding rail 12. Simultaneously, the driver 30 drives the cleaning brush 22 to rotate to brush the filter 10. The cleaning brush 22 follows the mounting bracket 34 up and down along the sliding rail 12. The mounting bracket 34 moves up and down along the sliding rail 12 in front of the filter 10. The cleaning brush 22 is located on an inner side of the mounting bracket 34 to contact the filter 10 to enable the cleaning brush 22 to brush the filter 10 when the cleaning brush 22 is driven to rotate by the driver 30. The screen 24 mounted between the mounting bracket 34 and the dust box 14 follows the mounting bracket 34 up and down along the sliding rail 12 to expand and contract. In one embodiment, the screen 24 is a folding screen. When the screen 24 follows the mounting bracket 34 up the sliding rail 12, the screen 24 unfolds to cover the front of the filter 10. When the screen 24 follows the mounting bracket 34 down the sliding rail 12, the screen folds to cover the dust box 14. When the cleaning brush 22 brushes the filter 10, the screen 24 mounted between the mounting bracket 34 and the dust box 14 covers the front of the filter 10 to prevent dirt from the filter 10 dropping out of the air filter A. Thus, the dirt is directed to drop into the dust box 14.

The mounting bracket 34 further includes a scraper 341 mounted between the mounting bracket 34 and the cleaning brush 22. The scraper 341 contacts the cleaning brush 22 to scrape the cleaning brush 22. For example, while the cleaning brush 22 is rotated by the driver 30 to brush the filter 10, the cleaning brush 22 in contact with the scraper 341 is scraped by the scraper 341 to clean the cleaning brush 22. The cleaning brush 22 can be disassembled from the mounting bracket 34 to be cleaned. The cleaning brush 22 disassembled from the mounting bracket 34 may also be used to clean the air filter A.

The filter 10 and the cleaning brush 22 are made of flexible material, such as wool felt or sponge. The filter 10 and the dust box 14 can be disassembled from the sliding rail 12. To disassemble the filter 10 from the sliding rail 12, the cleaning device 20 follows the driver 30 to move to the bottom of the sliding rail 12 until the cleaning device 20 is offset from the filter 10, and the filter is removed from the sliding rail 12. The filter 10 disassembled from the sliding rail 12 may be cleaned. The dust box 14 may be disassembled from the sliding rail 12 to empty out dirt from the dust box 14.

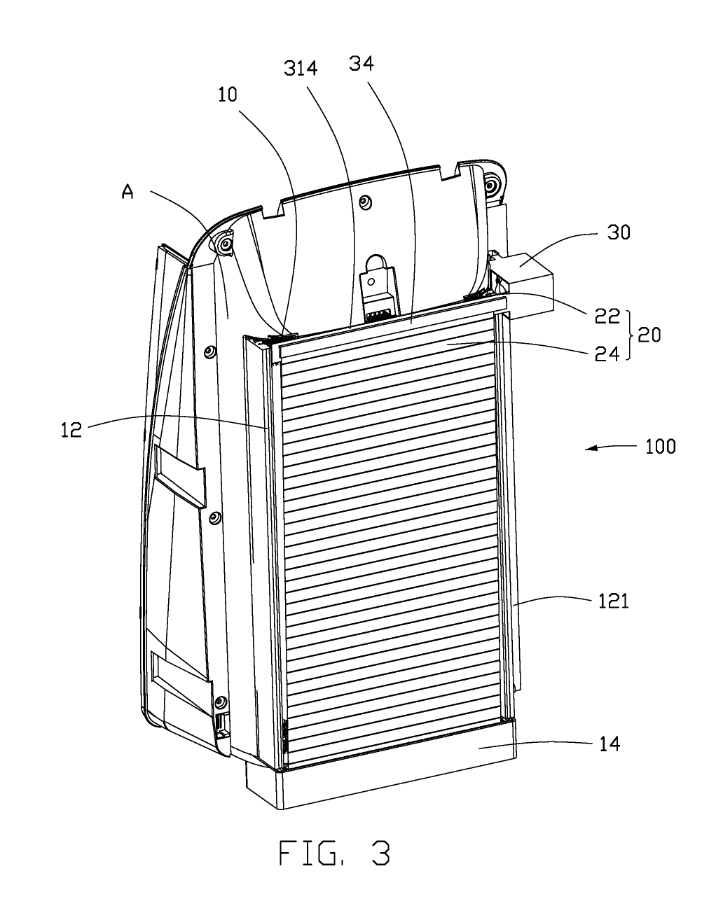

FIG. 3 illustrates when the air filter A is not in use, the cleaning device 20 is moved up along the sliding rail 12 to completely extend the screen 24 to cover the front of the filter 10. Thus, the screen 24 keeps dirt out of the air filter A when the air filter A is not in use. In one embodiment, when the air filter A is in use, the cleaning device 20 follows the driver 30 to move down the sliding rail 12 until the cleaning device 20 is located at a bottom of the sliding rail 12 (shown in FIG. 1), so that the cleaning device 20 is offset from the filter 10, the screen 24 is retracted, and the filter 10 can filter pollutants during normal use of the air filter A. The retracted screen 24 covers the dust box 14 to prevent the contents of the dust box 14 from polluting the air. When the air filter A is stopped, the cleaning device 20 follows the driver 30 up and down the sliding rail 12 to clean the filter 10, and the screen 24 follows the driver 30 to block the front of the filter 10 to prevent dirt cleaned off the filter 10 from falling outside of the air filter A. After the filter 10 is cleaned and the air filter A is not in use, the cleaning device 20 follows the driver 30 to move to a top of the sliding rail 12 to fully extend the screen 24 (shown in FIG. 3) to cover the filter 10, thereby protecting the filter 10.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A filter cleaning mechanism comprising:
a sliding rail;
a filter mounted to the sliding rail;
a dust box mounted to a bottom of the sliding rail;
a cleaning device mounted adjacent to the filter and above the dust box, the cleaning device comprising a cleaning brush and a screen;
a driver mounted to a side of the sliding rail and electrically coupled to the cleaning device, the driver moving up and down along the sliding rail; wherein:
the cleaning brush and the screen move along with the driver up and down the sliding rail;
the driver drives the cleaning brush to brush the filter; and
the screen blocks the front of the filter while the cleaning brush brushes the filter.

2. The filter cleaning mechanism of claim 1, wherein:
the driver is coupled to the sliding rail by a linking component; and
the linking component is mounted to the side of the sliding rail.

3. The filter cleaning mechanism of claim 2, wherein:
the linking component ascends and descends vertically;
the linking component comprises a gear mechanism, a belt mechanism, and a sleeve mechanism.

4. The filter cleaning mechanism of claim 1, wherein:
the driver comprises a mounting bracket transversely mounted across the sliding rail adjacent to the filter;
the cleaning brush is mounted to an inner side of the mounting bracket;
the screen is mounted between the mounting bracket and the dust box;
the mounting bracket follows the driver up and down along the sliding rail.

5. The filter cleaning mechanism of claim 4, wherein:
the mounting bracket is driven by the driver to move up and down along the sliding rail;
the driver drives the cleaning brush to rotate, and the cleaning brush brushes the filter up and down along the sliding rail.

6. The filter cleaning mechanism of claim 4, wherein:
the screen is a folding screen mounted between the mounting bracket and the dust box;
the screen follows the mounting bracket up along the sliding rail to unfold and cover the front of the filter;
the screen follows the mounting bracket down along the sliding rail to fold and cover the dust box.

7. The filter cleaning mechanism of claim 4, wherein:
the cleaning brush is adapted to be disassembled from the mounting bracket;
the mounting bracket comprises a scraper mounted between the mounting bracket and the cleaning brush;
the scraper contacts the cleaning brush;
the scraper scrapes the cleaning brush and the filter after the cleaning brush is removed.

8. The filter cleaning mechanism of claim 4, wherein:
the filter and the cleaning brush are made of wool felt, sponge, or other flexible material.

9. The filter cleaning mechanism of claim 1, wherein:
the filter is adapted to be disassembled from the sliding rail by:
moving the cleaning device by following the driver to the bottom of the sliding rail until the cleaning device is offset from the filter, and removing the filter from the sliding rail.

10. The filter cleaning mechanism of claim 1, wherein:
the filter is mounted to the sliding rail within an air filter;
when the filter is filtering air, the cleaning device is positioned at the bottom of the sliding rail;
when the air filter is not filtering air, the cleaning device follows the driver up and down along the sliding rail to clean the filter; and
when the cleaning device is positioned at a top opposite to the bottom of the sliding rail, the screen covers the front of the filter.

11. An air filter comprising a filter cleaning mechanism, the filter cleaning mechanism comprising:
a sliding rail;
a filter mounted to the sliding rail;
a dust box mounted to a bottom of the sliding rail;
a cleaning device mounted adjacent to the filter and above the dust box, the cleaning device comprising a cleaning brush and a screen;
a driver mounted to a side of the sliding rail and electrically coupled to the cleaning device, the driver moving up and down along the sliding rail; wherein:
the cleaning brush and the screen move along with the driver up and down the sliding rail;
the driver drives the cleaning brush to brush the filter; and
the screen blocks the front of the filter while the cleaning brush brushes the filter.

12. The air filter of claim 11, wherein:
the driver is coupled to the sliding rail by a linking component; and
the linking component is mounted to the side of the sliding rail.

13. The air filter of claim 12, wherein:
the linking component ascends and descends vertically;
the linking component comprises a gear mechanism, a belt mechanism, and a sleeve mechanism.

14. The air filter of claim 11, wherein:
the driver comprises a mounting bracket transversely mounted across the sliding rail in front of the filter;
the cleaning brush is mounted to an inner side of the mounting bracket;
the screen is mounted between the mounting bracket and the dust box;
the mounting bracket follows the driver up and down along the sliding rail.

15. The air filter of claim 14, wherein:
the mounting bracket is driven by the driver to move up and down along the sliding rail;
the driver drives the cleaning brush to rotate, and the cleaning brush brushes the filter up and down along the sliding rail.

16. The air filter of claim 14, wherein:
the screen is a folding screen mounted between the mounting bracket and the dust box;
the screen follows the mounting bracket up along the sliding rail to unfold and cover the front of the filter;
the screen follows the mounting bracket down along the sliding rail to fold and cover the dust box.

17. The air filter of claim 14, wherein:
the cleaning brush is adapted to be disassembled from the mounting bracket;
the mounting bracket comprises a scraper mounted between the mounting bracket and the cleaning brush;
the scraper contacts the cleaning brush;
the scraper scrapes the cleaning brush and the filter after the cleaning brush is removed.

18. The air filter of claim 14, wherein:
the filter and the cleaning brush are made of wool felt, sponge, or other flexible material.

19. The air filter of claim 11, wherein:
the filter is adapted to be disassembled from the sliding rail by:
moving the cleaning device by following the driver to the bottom of the sliding rail until the cleaning device is offset from the filter, and removing the filter from the sliding rail.

20. The air filter of claim 11, wherein:
the filter is mounted to the sliding rail within an air filter;
when the filter is filtering air, the cleaning device is positioned at the bottom of the sliding rail;
when the air filter is not filtering air, the cleaning device follows the driver up and down along the sliding rail to clean the filter; and
when the cleaning device is positioned at a top opposite to the bottom of the sliding rail, the screen covers the front of the filter.
